(19) United States
(12) Patent Application Publication
(10) Pub. No.: US 2025/0360654 A1
(43) Pub. Date: Nov. 27, 2025

(54) Spillage Prediction for Concrete Mixers

(71) Applicant: Total Vehicle Solutions Group Limited, Wisbech (GB)

(72) Inventors: Darren Davies, Buckingham (GB); Kevin Walker, Wisbech (GB); Matthew Hicks, Buckingham (GB); Vito Ronzano, JR., Wisbech (GB)

(21) Appl. No.: 19/108,157

(22) PCT Filed: Aug. 25, 2023
(86) PCT No.: PCT/GB2023/052211

§ 371 Date: Mar. 1, 2025

(30) Foreign Application Priority Data
Sep. 2, 2022 (GB) 2212833.4

(51) Int. Cl. B28C 5/42

(52) U.S. Cl. CPC B28C 5/422

(57) ABSTRACT

This specification describes systems, methods and apparatus for predicting and/or preventing spillage of a concrete mix from a concrete mixer vehicle (102). According to a first aspect of this specification, there is described a spillage indication system for a concrete mixer vehicle (102), the system comprising: one or more incline sensors (110A) for determining an inclination of the concrete mixer vehicle; one or more rotation sensors (110C) for determining a rotation speed of a concrete mixing drum (104) of the concrete mixer vehicle (102); a spillage indicator (200) for indicating a potential spillage of a concrete mix in the mixing drum (104) to an operator of the concrete mixing vehicle; one or more processors; and a memory, the memory containing computer readable instructions that, when executed by the one or more processors, cause the system to perform operations comprising: measuring the inclination of the concrete mixer vehicle using the one or more incline sensors (110A); measuring the rotation speed of the concrete mixing drum using the one or more rotation sensors (110C); determining, based on (i) a volume of the concrete mix in the mixing drum (ii) the inclination of the concrete mixer vehicle and (ii) the rotation speed of the concrete mixing drum, a predicted level line of the concrete mix in the mixing drum; comparing the predicted level line to a position of a discharge hole of the concrete mixing drum; and in response to determining that the predicted level line is above the discharge hole, activating the spillage indicator.

### FIELD

This specification describes systems, methods and apparatus for predicting and/or preventing spillage of a concrete mix from a concrete mixer vehicle.

### BACKGROUND

Concrete trucks carry as much payload as possible in order to maximise efficiency and operator profits. The “steady” level of concrete in the drum is therefore typically as high as possible, and up to the level of the discharge hole at the rear of the drum. When the vehicle is accelerating, the inertial force on the payload causes it to “slosh” backwards and it can flow above the discharge hole. Equally, when going up a hill, the level line of the concrete can be above the hole.

Discharging concrete on public highways etc. is an environmental issue and operators may be fined if this happens. To avoid it, the driver will usually set the drum to rotate in the charging direction, forcing the payload forwards in the drum thus reducing the risk of accidental discharge. This however increases energy consumption and more importantly can increase the risk of accidental roll-over as the rotation of the drum causes the payload to shift laterally and vertically as well as forwards.

### SUMMARY

According to a first aspect of this specification, there is described a spillage indication system for a concrete mixer vehicle, the system comprising: one or more incline sensors for determining an inclination of the concrete mixer vehicle; one or more rotation sensors for determining a rotation speed of a concrete mixing drum of the concrete mixer vehicle; a spillage indicator for indicating a potential spillage of a concrete mix in the mixing drum to an operator of the concrete mixing vehicle; one or more processors; and a memory, the memory containing computer readable instructions that, when executed by the one or more processors, cause the system to perform operations comprising: measuring the inclination of the concrete mixer vehicle using the one or more incline sensors; measuring the rotation speed of the concrete mixing drum using the one or more rotation sensors; determining, based on (i) a volume of the concrete mix in the mixing drum (ii) the inclination of the concrete mixer vehicle and (ii) the rotation speed of the concrete mixing drum, a predicted level line of the concrete mix in the mixing drum; comparing the predicted level line to a position of a discharge hole of the concrete mixing drum; and in response to determining that the predicted level line is above the discharge hole, activating the spillage indicator.

According to a second aspect of this specification, there is described a method of predicting spillage of a concrete mix from a concrete mixer, the method comprising: measuring an inclination of a concrete mixer vehicle using one or more incline sensors; measuring a rotation speed of a concrete mixing drum using one or more rotation sensors; determining, based on (i) a volume of the concrete mix in the mixing drum (ii) the inclination of the concrete mixer vehicle and (ii) the rotation speed of the concrete mixing drum, a predicted level line of the concrete mix in the mixing drum; comparing the predicted level line to a position of a discharge hole of the concrete mixing drum; and in response to determining that the predicted level line is above the discharge hole, activating the spillage indicator.

These, and other aspects, of this specification may include one or more of the following features, either alone or in combination.

Determining the predicted level line of the concrete mix in the mixing drum may comprise: determining a change in level line of the concrete mix relative to a current level line; and determining the predicted level line of the concrete mix from the current level line and the change in level line of the concrete mix relative to a current level line. Determining the predicted level line of the concrete mix from the initial level line may comprise modifying the determined change in level line based on a slump value-dependent response factor of the concrete mix prior to determining the predicted level line of the concrete mix.

The operations/method may further comprise determining a steady level line corresponding to a stationary concrete mixing vehicle on a flat surface based on geometry of the concrete mixing drum and the volume of the concrete mix in the mixing drum.

The operations/method may further comprise determining the volume of the concrete mix in the mixing drum from a payload weight of the concrete mix and a slump value of the concrete mix.

The operations/method may further comprise controlling rotation of the concrete mixing drum based on the predicted level line of the concrete mix.

The operations/method may be iterated for a plurality of time steps during a journey of the concrete mixing vehicle.

The one or more incline sensors may be configured to measure a current inclination of the of the concrete mixer vehicle. The predicted level line of the concrete mix in the mixing drum may comprise a current predicted level line of the concrete mix in the mixing drum. The one or more incline sensors are configured to predict a future inclination of the concrete mixer vehicle. The predicted level line of the concrete mix in the mixing drum may comprise a future predicted level line of the concrete mix in the mixing drum.

The system may further comprise one or more accelerometers configured to measure a longitudinal acceleration of the concrete mixing vehicle (i.e. acceleration in the forward direction). The operations may further comprise measuring the longitudinal acceleration of the concrete mixing vehicle using the one or more accelerometers. Determination of the predicted level line may further be based on (iv) the longitudinal acceleration of the concrete mixing vehicle.

According to a third aspect of this specification, there is described a computer implemented method for determining a drum rotation schedule for a concrete mixing vehicle, the method comprising: receiving a volume of concrete mix to be transported by the concrete mixing vehicle; receiving a journey route for the concrete mixing vehicle; for each of a plurality of locations in a sequence of locations on the received route: determining, based on the received route, an estimated incline of the concrete mixing vehicle at a respective location on the route; determining, based on (i) the volume of the concrete mix (ii) the estimated incline of the concrete mixing vehicle and (iii) geometry of the concrete mixing drum, an estimated level line of the concrete mix at the respective location; determining, based on the estimated level line of the concrete mix at the respective location, a target drum rotation speed at the respective location.

Determining, based on the estimated level line of the concrete mix at the respective location, a target drum rotation speed at the respective location may comprise determining that the estimated level line of the concrete mix at the respective location is above a position of a discharge hole of the concrete mixing drum. In response to determining that the estimated level line of the concrete mix at the respective location is above a position of a discharge hole of the concrete mixing drum, the method may comprise determining a target drum rotation speed at the respective location that results in a respective estimated level line of the concrete mix that is below the discharge hole of the concrete mixing drum.

Determining a target drum rotation speed at the respective location that results in a respective estimated level line of the concrete mix that is below the discharge hole of the concrete mixing drum may compromise iteratively, until the respective estimated level line of the concrete mix that is below the discharge hole of the concrete mixing drum: increasing or decreasing the drum rotation speed; determining, based on (i) the volume of the concrete mix (ii) the estimated incline of the concrete mixing vehicle (iii) geometry of the concrete mixing drum and (iv) the drum rotation speed, a respective estimated level line of the concrete mix at the respective location; determining whether the respective estimated level line of the concrete mix at the respective location is above the position of the discharge hole of the concrete mixing drum

Determining the estimated level line of the concrete mix may comprise the use of computational fluid dynamics. Determining the estimated level line of the concrete mix at a respective location may be further based on a target drum rotation speed at a previous location in the sequence of locations.

According to a fourth aspect of this specific ion, there is described computer program product comprising computer readable instructions that, when executed by system comprising one or more processors, cause the system to perform any one or more of the method disclosed herein.

According to a fifth aspect of this specific ion, there is described system comprising one or more processors and a memory, the memory storing computer readable instructions that, when executed the one or more processors, cause the system to perform any one or more of the method disclosed herein.

### BRIEF DESCRIPTION OF THE DRAWINGS

Example implementations will be described by way of reference to the accompanying drawings, in which:

FIG. 1 shows a schematic diagram of a concrete mixer vehicle;

FIG. 2 shows a schematic overview of an example method for triggering a spillage indicator of a concrete mixer;

FIG. 3 shows a schematic overview of an example method for determining a rotation schedule of a concrete mixer based on predicted spillages during a journey;

FIG. 4 shows a flow diagram of an example method for triggering a spillage indicator of a concrete mixer;

FIG. 5 shows a flow diagram of an example method for determining a rotation schedule of a concrete mixer based on predicted spillages during a journey; and

FIG. 6 shows a schematic example of a computing system/apparatus for performing any of the methods described herein.

### DETAILED DESCRIPTION

In order to manage the spillage risk, along with other safety and quality risks, the systems and methods described herein provide an objectively assessed indicator of spillage risk, either in real time during a journey and/or in advance based on a planned journey route.

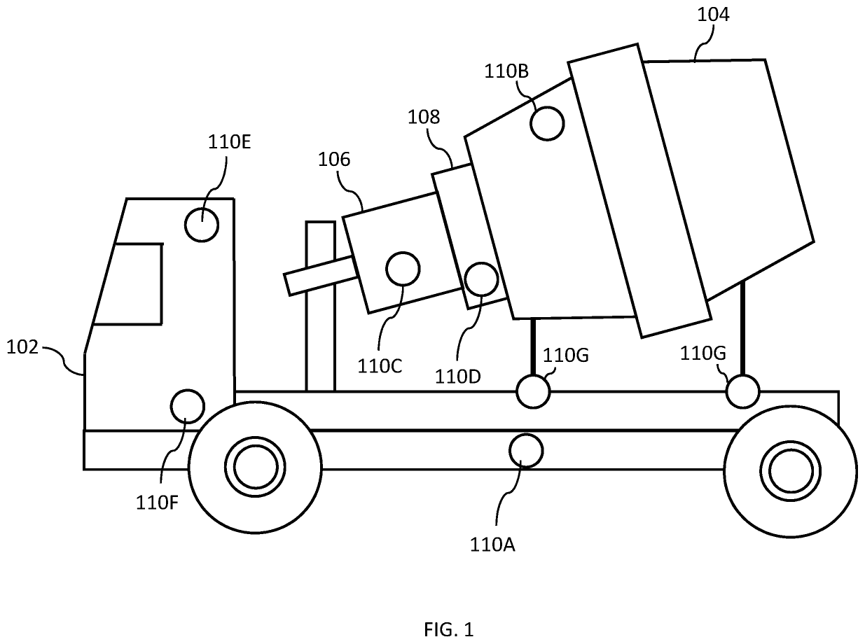

FIG. 1 shows a schematic diagram of an example concrete mixing vehicle 102 (e.g. a truck or lorry) comprising a concrete mixing drum 104. The vehicle further comprises a cab, from which the vehicle may be operated/driven by an operator.

The vehicle 100 comprises a drum 104 for mixing a concrete mix (also referred to herein as a “payload”). The drum 104 is rotatable about a central axis to mix the concrete. The drum 104 may contain internal protrusions (not shown) to aid turning of the concrete mix. A drive motor 106 is coupled to drum via a gearbox 108. The drive motor 106 applies torque to the drum 104 via the gearbox 108 in order to rotate the drum 104. The drive motor 106 may be a bi-directional drive motor, i.e. capable of rotating the drum 104 both clockwise and anti-clockwise around the central axis. The drive motor 106 may be a hydraulic or electric motor. The drum 104 comprises a discharge hole (which may also be referred to as a “discharge outlet”) through which concrete mix is unloaded from the drum 104.

The system 100 further comprises a plurality of sensors 110. The sensors 110 are configured to measure properties of the system 100, the vehicle 102 and/or the concrete mix in the concrete mixing drum 104. The sensors 110 may supply the sensor data to an electronic control unit (ECU), which can control various elements of the concrete mixing vehicle 102 based on the received sensor data.

The plurality of sensors 110 may comprise one or more incline sensors 110A (also referred to herein as “tilt sensors”). The one or more incline sensors measure an incline (e.g. an angle of inclination or tilt) of the vehicle 102 and/or concrete mixing drum 104. Any type of incline sensor known in the art may be used. For example, the one or more incline sensors may comprise one or more electrolytic incline sensors, one or more

MEMs-based sensors and/or one or more optical incline sensors. In some implementation, the one or more incline sensors 110A additionally comprise one or more “look ahead” sensors for predicting an upcoming tilt of the vehicle 102/drum 104. Such sensors may, for example comprise optical sensors that observe upcoming road conditions and estimate a future incline of the vehicle 102, and/or a satellite location system based on known inclinations at points along a journey. The one or more incline sensors can, in some embodiments, be a simple angle sensor fitted on the drum sub-frame.

The plurality of sensors 110 may comprise one or more load sensors 110G. The load sensors 110A are configured to measure the load of the concrete mixer, e.g. the mass of the drum 104 plus the mass of the concrete mix in the drum 104. In some embodiments, the one or more load sensors comprises at least two load sensors 110G: a front load sensor arranged to measure the load at the front of the drum 104 (i.e. the end closest to the drum 104 mouth); and a rear load sensor arranged to measure the load at the rear of the drum 104 (i.e. the end furthest from the drum 104 mouth). The load sensors 110G may be zeroed prior to the concrete mix being loaded to account for build-up of dried concrete in the drum

The plurality of sensors may further comprise a drum temperature sensor 110B configured to measure the temperature of the drum or the concrete in the drum directly. The temperature can be a contact temperature (either internal or external to the drum) or a non-contact temperature measurement. The temperature of the concrete mix can be an important factor in determining the slump of the concrete, since the temperature affects the evaporation rate of moisture in the concrete mix.

The plurality of sensors may further comprise one or more (e.g. a plurality) of motor state sensors 110C configured to measure the state of the motor 106 driving the drum 104, e.g. the current/voltage supplied to the motor for an electric motor, the input and output hydraulic pressures for a hydraulic motor, the motor temperature, the hydraulic fluid temperature and/or the motor rotation speed. The motor state sensors 110C may further comprise a drum speed sensor, such as an optical encoder or magnetic sensor, though this may alternatively be fitted to the drum itself, when present.

The plurality of sensors may further comprise one or more (e.g. a plurality) of gearbox state sensors 110D configured to measure the state of the drum gearbox 108, e.g. the input torque/rotation speed to the gearbox, the gearbox temperature, the gearbox fluid level, or the like. Each of the gearbox state sensors 110E may be fitted to the gearbox directly, or to some other part of the system, e.g. the motor for an input torque sensor.

The plurality of sensors may further comprise one or more location sensors 110E configured to determine the location of the vehicle 100. For example, the one or more location sensors 110E may be satellite positioning sensors, such as a GPS system.

The plurality of sensors may further comprise one or more speed sensors 110F configured to determine the speed of the vehicle 102.

The plurality of sensors may further comprise one or more of: one or more aeration sensors for measuring the aeration of the concrete mix; one or more tilt sensors configured to measure a lateral and/or longitudinal inclination of the concrete mixing drum and/or vehicle; and/or one or more accelerometers configured to measure a longitudinal and/or latitudinal acceleration of the concrete mixing drum and/or vehicle (this may alternatively be determined from real-time location data, such as GPS data). Many other examples of relevant sensors will be apparent to those skilled in the art.

The plurality of sensors may further comprise one or more vision-based sensor systems (e.g. cameras) and/or one or more LIDAR-based sensor systems. These may be used to determine additional contextual data for the journey of the concrete mixer vehicle 102. For example, an image recognition algorithm may be applied to captured images to detect, for example, traffic conditions, speed limits, lane markings, obstacles or the like.

It will be appreciated that there are multiple possible sensors or combinations of sensors that can be arranged to measure the variables required for the methods used herein. Multiple possible sensors or combinations of sensors that can be arranged to measure the variables required for the methods used herein. As an example, the input torque may be determined using a direct torque measurement via torque sensor on the drive system. Alternatively, the torque can be derived indirectly from other measurements of the motor, such as input current, input and output hydraulic pressures or the like. As another example, the drum speed may be determined from the motor speed and the gearbox ratio, or alternatively measured directly.

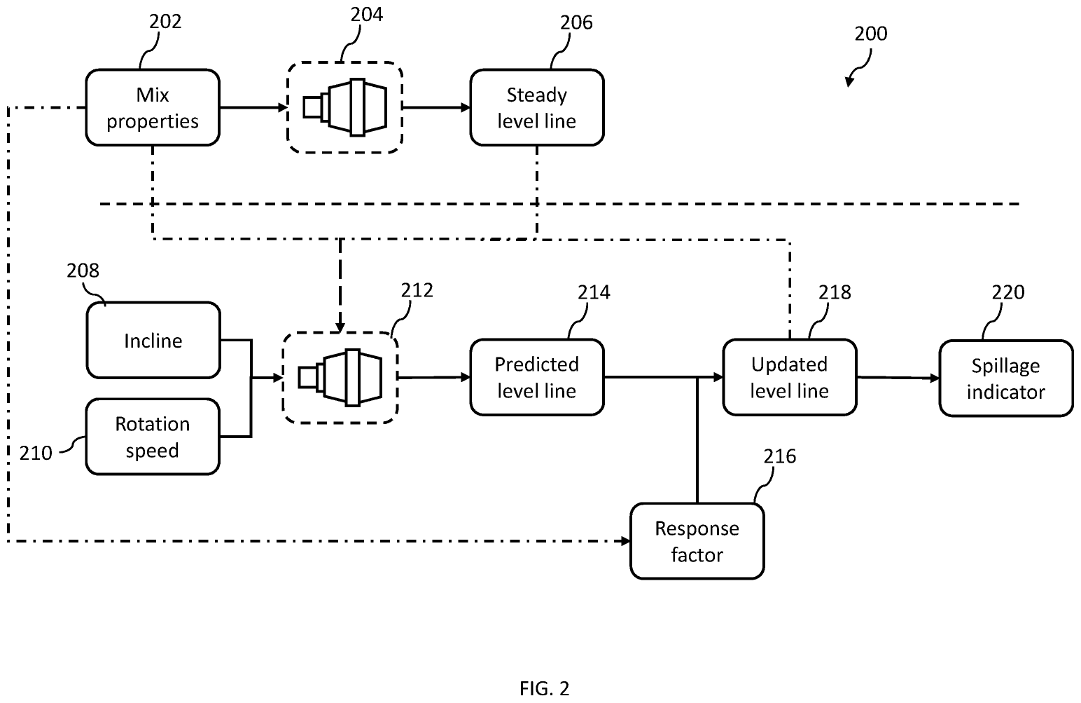

The sensors may be connected to an electronic control unit (ECU, not shown) of the concrete mixer. The ECU may use the sensor data to determine properties of the concrete drum 104, vehicle 102 and/or concrete mix, and to control these and/or other elements of the system, as described below in relation to FIGS. 2-5.

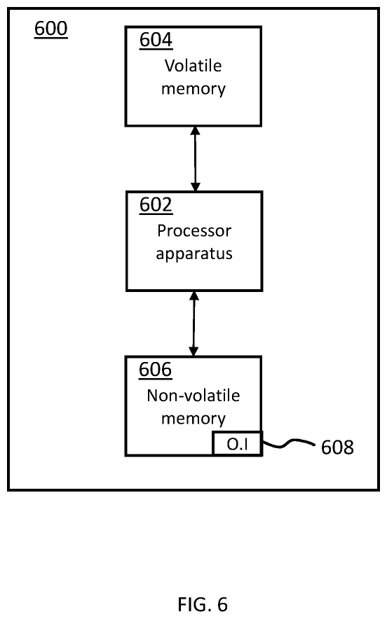

FIG. 2 shows a schematic overview of an example method 200 for triggering a spillage indicator of a concrete mixer. The method may be performed by one or more computer systems, such as the system described in relation to FIG. 6. The computing system may be part of an ECU of a concrete mixing vehicle, such as the vehicle described in relation to FIG. 1.

Initially, a steady level line 206 for the concrete mix (also referred to herein as the “payload”) in the vehicle is determined from properties of the concrete mix 202 and a model of the concrete mixing drum 204. The steady level line 206 indicates the level line of the concrete mix (i.e. the line defining how high the surface of the concrete mix is in the mixing drum) when the concrete mixing vehicle is on a level surface. The level line includes at least the height of the payload adjacent to the discharge hole of the drum.

The properties of the concrete mix 202 may comprise the volume of the concrete mix. Alternatively, the volume may be derived from a mass of the concrete mix and density of the concrete mix. The mass may be measured by load cells of the concrete mixing vehicle, as described above in relation to FIG. 1, or alternatively manually entered. The density may be determined from the slump of the concrete mix, which may be manually entered or determined using a slump model, such as the model described in co-pending UK patent application no. 2208264.8, entitled “Slump Estimation for Concrete Mixers”, the contents of which are incorporated herein by reference.

The model of the concrete mixing drum 204 may be a computer model of the concrete drum. The model of the concrete mixing drum 204 accounts for the internal geometry of the concrete mixing drum, e.g. its size and shape, which may include the size and shape of any internal protrusions. The model 204 may be a static model, i.e. have no motion. The steady state level line 206 for a given volume of concrete mix may, for example, be based on the height of the level line in the mixing drum as a function of volume of concrete mix as determined by a computer simulation and/or experimental data. In some implementations, this may take the form of a look up table or an interpolated function. The steady state level line 206 for a given volume of concrete mix may alternatively be calculated directly using a computer simulation that utilises a geometric model of the drum.

During a journey, the incline 208 of the concrete mixing vehicle is measured/monitored using one or more incline sensors on the vehicle. The rotation speed 210 of the mixing drum is also measured/monitored using sensors associated with the mixing drum. In some implementations, the longitudinal acceleration may also be measured/monitored. These quantities may be measured periodically (e.g. once every second) or continuously monitored.

The measured incline 208 and drum rotation speed 210 are used by a drum model 212 to determine a prediction of the level line 214 of the concrete mix in the mixing drum. In some implementations, the longitudinal acceleration, mix properties 202 and/or steady level line 206 may additionally be used to determine the predicted level line.

The predicted level line 214 may be calculated directly by the drum model 212. Alternatively, a change in the level line with respect to the steady level line 206 or a previously determined level line may be determined, then applied to the steady level line 206 or previously determined level line respectively to determine the predicted level line 214.

When the rotation speed 210 is zero, a static drum model may be used to determine the level line in a similar manner to how the steady state level line is determined. When the drum rotation speed 210 is non-zero, a dynamic drum model may be used.

The drum model 212 may include the internal geometry of the drum. The drum model 212 may include the geometry of screws/internal protrusions in the drum. The drum model 212 may be a computational fluid dynamics (CFD) model, in which a CFD calculation is performed to determine the level line that depends on the drum geometry, screw geometry, slump value, rotation speed and concrete volume. For example, a low density payload (e.g. floor screeding) will respond differently to drum rotation compared to higher density/lower slump concrete.

In some embodiments, the drum model 212 may comprise a look-up table for a given type of concrete drum that provides the level lines for a concrete mix given the concrete mix volume, concrete mix slump, incline and rotation speed. The level lines in the look-up table may have been determined using computational fluid dynamics, as described above, or empirically using experimental data. In use, the concrete volume and slump, as well as the current/future values of the incline and drum rotation speeds are used to look up the level line in the table.

In some embodiments, the drum model may be based on measurements of the drum load taken by the load cells of the vehicle. A plurality of load cells may be present, distributed along the length of the drum (i.e. from front to back). For example, two load cells may be present, one load cell positioned at or near the front of the drum, and the other at or near the rear of the drum. Each drum cell measures a mass of the drum at their respective locations. Based on the masses measured at each load cell and the total payload, the current level line can be inferred. For example, if the level line is tilted backwards (e.g. when going uphill or accelerating) the rear load cell measure a higher mass than the front load cell as the payload is shifted backwards. The total mass of the payload does not change, but its distribution between the load cells does.

In some embodiments, a screw efficiency may also be used to determine the level line of the concrete mix in a rotating drum. The screw efficiency is a slump-dependent measure of how the screw (i.e. the internal protrusions of the drum) affects the concrete. Typically, the screw will have more effect on high viscosity (i.e. low slump) concrete mix than on low viscosity (i.e. high slump) concrete mix.

In some embodiments, a slump-dependent response factor 216 may be applied to the predicted level line 214 to account for different response rates of concrete mixes with different slump values/viscosities, i.e. the time lag between input and response in those mixes. This results in an updated level line 218. The response factor 216 may be in the form of a multiplicative factor between zero and one that may alter the determined level line 214. Typically, lower viscosity/high slump payloads (e.g. water-like consistencies) will respond more quickly to variations in their conditions, such as a change in road incline and/or drum rotation rates. In such cases, the level change of the payload may be practically instantaneous, i.e. have a response factor 216 that is close to one. By contrast, higher viscosity/low slump concrete has a slower response, so there may be a delay between the change in conditions (e.g. road incline and/or drum rotation rates) and the change in level line of the concrete mix. In such case the response factor 216 may, for example be around 0.5. The response factor 216 each slump value is stored by the system performing the method in a memory, and may have been derived from computational fluid dynamics modelling and/or empirical testing. During the method, the concrete mix properties 202 (e.g. the slump) are used to select the required response factor from the memory.

The predicted level line 214 or, if the response factor is applied, the updated level line 218 is compared to the height of the discharge hole on the concrete mixing drum. If said level line determined to be above the discharge hole, then the concrete can spill out. A spillage indicator 220 is activated in response to such a determination to warn an operator of the vehicle that a spillage may occur, e.g. warning them to take remedial action to prevent a spillage. The spillage indicator 220 may, for example be a warning light in a cab of the vehicle, a warning icon/symbol/message on a graphical user interface in the cab of the vehicle and/or an audio warning provided by an audio system in the cab of the vehicle. In some embodiments, the spillage indicator 220 may be displayed on a HUD in the cab.

In some embodiments, the spillage indicator is a binary indicator, indicating that a spillage is likely to occur. Alternatively, the spillage indicator may be a continuous warning level, for example a zero indicating no risk and a maximum value (e.g. one hundred) indicating a certain spillage. Alternatively, the spillage indicator may be a continuous warning level, for example indicating low/medium/high risk. The warning level may be determined based on how close the level line of the concrete mix is to the discharge hole, with level lines below the discharge hole having a lower risk, at or just around (i.e. within a threshold distance of) the discharge hole having a medium risk, and above the discharge hole having a high risk.

In some implementations, additional actions may be triggered if the level line is determined to be above the height of the discharge hole on the concrete mixing drum. For example, the rotation speed of the concrete mixing drum may be altered in order to change the level line and avoid spillage. Starting from no rotation, or the current rotation speed 210, the drum rotation model 212 may be used to determine a predicted level line 214, 218 at increasingly higher rotation speeds until a level line that does not exceed the height of the discharge hole is found. The drum is then rotated at the corresponding speed to prevent the spillage.

Alternatively, starting from a maximum rotation speed, the drum rotation model 212 may be used to determine a predicted level line 214, 218 at decreasing rotation speeds until a level line that exceeds the height of the discharge hole is found. The drum is then rotated at the speed corresponding to the previous rotation speed in the sequence to prevent the spillage.

In some embodiments, both rotation determination methods may be available, with the one used depending on how high the level line is above the discharge hole. When the level line is less than a threshold height above the discharge hole, the increasing drum speed method may be used. When the level line is greater than a threshold height above the discharge hole, the decreasing drum speed method may be used. This can result in a faster determination of the desired drum rotation speed.

In some embodiments, pre-set rotation speeds may be used depending on the warning level for a spillage. For example, the drum rotation speed may be zero when the risk is low, a first non-zero (i.e. intermediate) value when the risk is medium, and a maximum value when the risk is high.

In some embodiments, the spillage indications and/or the determined level lines for a journey may be logged by the ECU of the vehicle in a memory/the cloud. In some embodiments, locations may be logged alongside this data. This can allow potential spillage locations to be identified, for example in order to facilitate a clean-up operation.

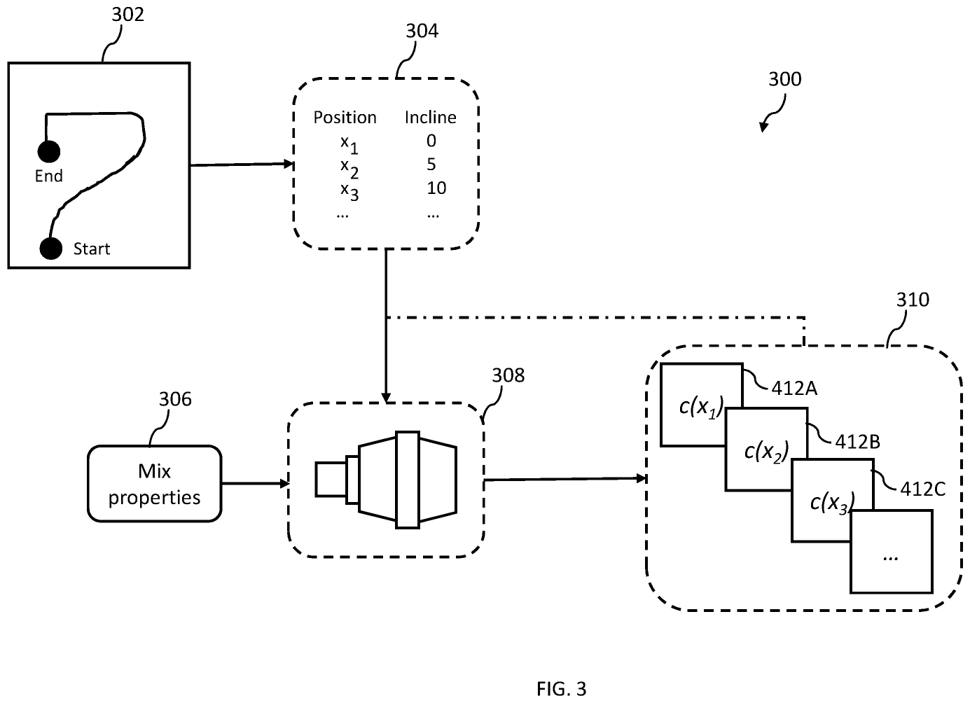

FIG. 3 shows a schematic overview of an example method 300 for determining a rotation schedule of a concrete mixer based on predicted spillages during a journey. The method may be performed by one or more computer systems, such as the system described in relation to FIG. 6. The resulting rotation schedule 310 may loaded into an ECU of a concrete mixer vehicle for use during the journey.

A planned route 302 for the concrete mixer vehicle is received. The planned route 302 comprises a start location and an end location, and a path between the two. In some implementations, the planned start of the journey may also be received, and/or a target end time.

Based on the route 302, a set of incline values 304 is determined, each incline value corresponding to a location (e.g. a single position or a range of positions) on the route 302. The incline may, for example, be measured as an angle (e.g. in degrees or radians) or a ratio (e.g. 1 in X, where X is a number). The incline at a location may be determined from known inclines at locations on the route. Alternatively or additionally, it may be estimated from known road heights/contours on the route.

A set of properties 306 of the concrete mix are also received. The set of properties 306 may comprise a volume of the concrete mix to be transported during the journey. The set of properties 306 may alternatively or additionally comprise a slump of the concrete mix to be transported during the journey. Other properties, such as a mass of the concrete mix, may also be included.

For each of a plurality of locations along the route, a drum model 308 is used to determine a respective drum rotation speed for the location from the incline at that location and the concrete mix properties 306. The determined drum rotation speed is added to a drum rotation schedule 310 that specifies how the concrete mixing should be rotated at each stage of the journey 302 in order to avoid spillage.

The drum rotation 308 model may be a CFD model, as described above in relation to FIG. 2. Alternatively, the drum rotation 308 model may be a look-up table based on simulated or experimental level lines, again as described above in relation to FIG. 2. The drum rotation model 308 may be used to determine a predicted level line for the concrete mix under a set of input conditions (e.g. rotation speed, concrete volume, concrete slump, incline).

To determine a drum rotation speed for each location, the method may first check whether a predicted level line for the concrete mix is above the discharge hole of the drum when the drum is not rotating using the drum model 308. If the predicted level line for the concrete mix is below the discharge hole of the drum at a location when the drum is not rotating, then the target drum rotation speed is set to zero for that location.

If the predicted level line for the concrete mix is above the discharge hole of the drum at a location when the drum is not rotating, then the drum model 308 is used to determine a target drum rotation speed that results in a level line below the discharge hole. The method may be an iterative method, in which the drum rotation speed is progressively increased from an initial value (e.g. zero), with the level line at each rotation speed compared to the discharge hole height. When the lowest rotation speed with a level line below the discharge hole is reached, the target drum rotation speed at that location may be set to at least that rotation speed, e.g. to that rotation speed.

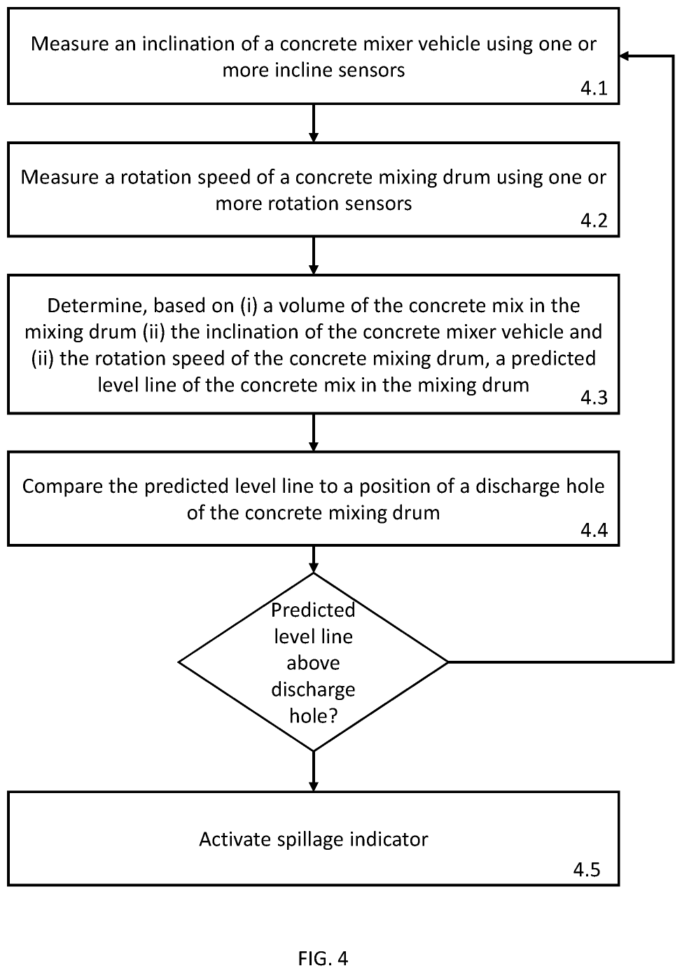

FIG. 4 shows a flow diagram of an example method for triggering a spillage indicator of a concrete mixer. The method may be performed by one or more computer systems, such as the system described in relation to FIG. 6. The computing system may be part of an ECU of a concrete mixing vehicle, such as the vehicle described in relation to FIG. 1.

Prior to the method, a steady level line corresponding to a stationary concrete mixing vehicle on a flat surface based on geometry of the concrete mixing drum and the volume of the concrete mix in the mixing drum, for example as described in relation to FIG. 1.

At operation 4.1, an inclination of a concrete mixer vehicle is measured using one or more incline sensors of the vehicle. The one or more incline sensors may be configured to measure a current inclination of the concrete mixer vehicle or a predicted future inclination of the concrete mixer vehicle.

At operation 4.2, a rotation speed of a concrete mixing drum on the vehicle is measured using one or more rotation sensors coupled to the drum. The rotation speed may include a rotation direction of the concrete mixing drum.

In some implementation, a longitudinal acceleration (i.e. acceleration in the forward direction) of vehicle may also be measured using one or more accelerometers on the concrete mixing vehicle.

At operation 4.3, a predicted level line of the concrete mix in the mixing drum is determined based on (i) a volume of the concrete mix in the mixing drum (ii) the inclination of the concrete mixer vehicle and (ii) the rotation speed of the concrete mixing drum. Determination of the predicted level line may further be based on (iv) the longitudinal acceleration of the concrete mixing vehicle. Where the current inclination of the vehicle is measured, the predicted level line of the concrete mix in the mixing drum may comprise a current (or imminent) predicted level line of the concrete mix in the mixing drum. Where the future inclination of the vehicle is predicted, the predicted level line of the concrete mix in the mixing drum may comprise a future predicted level line of the concrete mix in the mixing drum.

The volume of the concrete mix may be input manually into the system performing the method. Alternatively, the method may comprise determining the volume of the concrete mix in the mixing drum from a payload weight of the concrete mix (e.g. as measured by load sensors of the concrete mixing vehicle) and a slump value of the concrete mix (from which a density may be derived).

A geometric model of the concrete mixing drum may be used to determine the level line. If the drum is currently stationary, a static model of the drum may be used. If the drum is currently rotating, a dynamic model of the drum may be used, e.g. a computational fluid dynamics model. Alternatively, in some implementations, a look-up table based on simulated and/or experimental drum data may be used to determine the predicted level line.

Determining the predicted level line of the concrete mix in the mixing drum may comprise determining a change in level line of the concrete mix relative to a current level line or a steady state level line. Determining the predicted level line of the concrete mix may comprise applying the change in level line of the concrete mix relative to a current level line/steady state level line to the current level line. The predicted level line/change in level line may be modified based on a slump value-dependent response factor of the concrete mix prior to determining the predicted level line of the concrete mix.

At operation 4.4, the predicted level line is compared to a position of a discharge hole of the concrete mixing drum. If the level line is above the position of the discharge hole, the method proceeds to operation 4.5, otherwise, the method returns to operation 4.1.

At operation 4.5, a spillage indicator is activated (or caused to be activated). The spillage indicator may, for example, be a warning light, warning message and/or warning icon that is communicated to an operator of the vehicle in the vehicle cab, e.g. via an in-cab display or dedicated warning system. Alternatively or additionally, an audio indicator may be output by an audio system in the cab of the vehicle.

In some implementations, rotation of the mixing drum may be controlled based on the predicted level line of the concrete mix. A suitable forward rotation speed (i.e. pushing the concrete mix forward into the drum, away from the discharge hole) may be determined using a model (e.g. a dynamic geometric model or a look-up table) such that the level line of the mix is below the discharge hole of the mixing drum. For example, the minimum rotation speed that results in a level line below the discharge hole may be used, as described above in relation to FIG. 2.

The method may be iterated throughout a journey to monitor the level line of the concrete mix and reduce spillages.

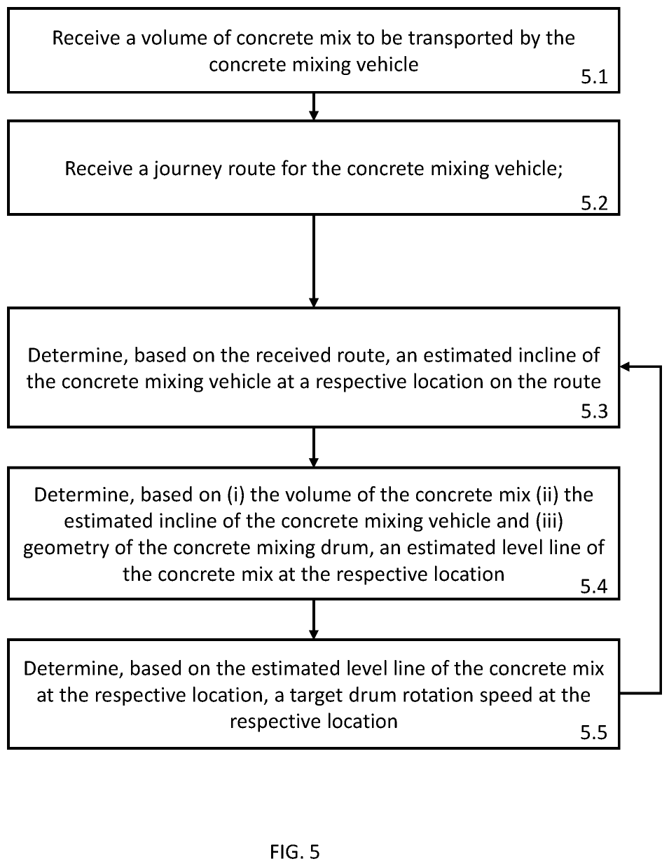

FIG. 5 shows a flow diagram of an example method for determining a rotation schedule of a concrete mixer based on predicted spillages during a journey. The method may be performed by one or more computer systems, such as the system described in relation to FIG. 6. The computing system may be part of an ECU of a concrete mixing vehicle, such as the vehicle described in relation to FIG. 1, or may be separate computer system. The method may be performed prior to a journey of a concrete mixer.

At operation 5.1, a volume of concrete mix to be transported is received. The volume may be input to the computing system by a user manually. Alternatively, a mass of concrete and a density may be input (or a slump value, from which density may be derived), and used to determine the volume of concrete mix.

At operation 5.2, a journey route for the concrete mixing vehicle is received. The journey rout comprises a start location, an end location and one or more locations between the start and end point that a concrete vehicle will pass through when travelling between them. The start and end points may be manually entered by a user, with the route between them determined automatically by the computing system based on e.g. a shortest journey time or a shortest distance travelled. Alternatively, the whole route may be specified manually by a user.

Operations 5.3 to 5.5 are performed for each of a plurality of locations in the journey. The operations may be performed for locations sequentially, e.g. starting from an initial location on the journey and ending at a destination location.

At operation 5.3, an estimated incline of the concrete mixing vehicle at a respective location on the route is estimated based on the journey route. For example, known inclinations of roads along the journey route may be used to estimate a vehicle inclination. Alternatively or additionally, mapping data (e.g. contour lines or other known height data) may be used to estimate an inclination at the location. In some implementation, an estimated longitudinal acceleration of the concrete vehicle at the location may also be estimated, for example based on speed limits and/or traffic control measures at or near the location on the route.

At operation 5.4, an estimated level line of the concrete mix at the respective location is determined based on (i) the volume of the concrete mix (ii) the estimated incline of the concrete mixing vehicle and (iii) geometry of the concrete mixing drum. In some implementations the estimated longitudinal acceleration at a location may also be used to estimate the level line. A geometric model of the concrete mixing drum may be used to determine the level line. If the drum is currently stationary, a static model of the drum may be used. If the drum is currently rotating, a dynamic model of the drum may be used, e.g. a computational fluid dynamics model. Alternatively, in some implementations, a look-up table based on simulated and/or experimental drum data may be used to determine the predicted level line.

At operation 5.5, a target drum rotation speed at the respective location is estimated based on the estimated level line of the concrete mix at the respective location. The method may then return to operation 5.3, and operations 5.3 to 5.5 performed again for the next location in the journey.

Determining a target drum rotation speed may comprise determining whether the estimated level line of the concrete mix at the respective location is above a position of a discharge hole of the concrete mixing drum. If the estimated level line is below the discharge hole, then the target drum rotation speed for that location may be set to zero, i.e. the drum will not rotate to prevent spillage (though it may rotate for other purposes, such as mixing/turning over the concrete mix).

In response to determining that the estimated level line of the concrete mix at the respective location is above a position of a discharge hole of the concrete mixing drum, a non-zero target drum rotation speed at the respective location may be determined. The non-zero drum rotation speed is determined such that it results in a respective estimated level line of the concrete mix that is below the discharge hole of the concrete mixing drum. For example, the drum speed may be iteratively increased form an initial speed (e.g. zero or the rotation speed from the journey previous location). At each iteration, a new estimated level line estimated base on (i) the volume of the concrete mix (ii) the estimated incline of the concrete mixing vehicle (iii) geometry of the concrete mixing drum and (iv) the drum rotation speed. The new estimated level line is compared to the position of the discharge hole of the concrete mixing drum. If the new estimated level line is below the discharge hole, the drum rotation speed for the iteration is selected as the target drum rotation speed. If the new estimated level line is above the discharge hole, the drum speed is increased and this part of the method performed again.

The method results in a drum rotation profile/schedule for the whole journey, comprising a target drum rotation speed for each part on the journey. The mixing drum may then be controlled during the journey based on the drum rotation profile/schedule.

FIG. 6 shows a schematic overview of a computer system for use in performing any of the methods described herein. The system/apparatus 600 may form at least a part of a concrete mixer, e.g. part of an ECU of a concrete mixer.

The apparatus (or system) 600 comprises one or more processors 602. The one or more processors control operation of other components of the system/apparatus 600. The one or more processors 602 may, for example, comprise a general-purpose processor. The one or more processors 602 may be a single core device or a multiple core device.

The one or more processors 602 may comprise a Central Processing Unit (CPU) or a graphical processing unit (GPU). Alternatively, the one or more processors 802 may comprise specialised processing hardware, for instance a RISC processor or programmable hardware with embedded firmware. Multiple processors may be included.

The system/apparatus comprises a working or volatile memory 604. The one or more processors may access the volatile memory 604 in order to process data and may control the storage of data in memory. The volatile memory 604 may comprise RAM of any type, for example, Static RAM (SRAM) or Dynamic RAM (DRAM), or it may comprise Flash memory, such as an SD-Card.

The system/apparatus comprises a non-volatile memory 606. The non-volatile memory 606 stores a set of operation instructions 608 for controlling the operation of the processors 602 in the form of computer readable instructions. The non-volatile memory 606 may be a memory of any kind such as a Read Only Memory (ROM), a Flash memory or a magnetic drive memory.

The one or more processors 602 are configured to execute operating instructions 608 to cause the system/apparatus to perform any of the methods described herein. The operating instructions 608 may comprise code (i.e. drivers) relating to the hardware components of the system/apparatus 600, as well as code relating to the basic operation of the system/apparatus 600. Generally speaking, the one or more processors 602 execute one or more instructions of the operating instructions 608, which are stored permanently or semi-permanently in the non-volatile memory 606, using the volatile memory 604 to store temporarily data generated during execution of said operating instructions 608.

Any mentioned apparatus and/or other features of particular mentioned apparatus may be provided by apparatus arranged such that they become configured to carry out the desired operations only when enabled, e.g. switched on, or the like. In such cases, they may not necessarily have the appropriate software loaded into the active memory in the non-enabled (e.g. switched off state) and only load the appropriate software in the enabled (e.g. on state). The apparatus may comprise hardware circuitry and/or firmware. The apparatus may comprise software loaded onto memory. Such software/computer programs may be recorded on the same memory/processor/functional units and/or on one or more memories/processors/functional units.

Any mentioned apparatus/circuitry/elements/processor may have other functions in addition to the mentioned functions, and that these functions may be performed by the same apparatus/circuitry/elements/processor. One or more disclosed aspects may encompass the electronic distribution of associated computer programs and computer programs (which may be source/transport encoded) recorded on an appropriate carrier (e.g. memory, signal).

Any “computer” described herein can comprise a collection of one or more individual processors/processing elements that may or may not be located on the same circuit board, or the same region/position of a circuit board or even the same device. In some examples one or more of any mentioned processors may be distributed over a plurality of devices. The same or different processor/processing elements may perform one or more functions described herein.

The term “signalling” may refer to one or more signals transmitted as a series of transmitted and/or received electrical/optical signals. The series of signals may comprise one, two, three, four or even more individual signal components or distinct signals to make up said signalling. Some or all of these individual signals may be transmitted/received by wireless or wired communication simultaneously, in sequence, and/or such that they temporally overlap one another.

With reference to any discussion of any mentioned computer and/or processor and memory (e.g. including ROM, CD-ROM etc.), these may comprise a computer processor, Application Specific Integrated Circuit (ASIC), field-programmable gate array (FPGA), and/or other hardware components that have been programmed in such a way to carry out the inventive function.

The applicant hereby discloses in isolation each individual feature described herein and any combination of two or more such features, to the extent that such features or combinations are capable of being carried out based on the present specification as a whole, in the light of the common general knowledge of a person skilled in the art, irrespective of whether such features or combinations of features solve any problems disclosed herein, and without limitation to the scope of the claims. The applicant indicates that the disclosed aspects/examples may consist of any such individual feature or combination of features. In view of the foregoing description, it will be evident to a person skilled in the art that various modifications may be made within the scope of the disclosure.

While there have been shown and described and pointed out fundamental novel features as applied to examples thereof, it will be understood that various omissions and substitutions and changes in the form and details of the devices and methods described may be made by those skilled in the art without departing from the scope of the disclosure. For example, it is expressly intended that all combinations of those elements and/or method steps which perform substantially the same function in substantially the same way to achieve the same results are within the scope of the disclosure. Moreover, it should be recognized that structures and/or elements and/or method steps shown and/or described in connection with any disclosed form or examples may be incorporated in any other disclosed or described or suggested form or example as a general matter of design choice. Furthermore, in the claims means-plus-function clauses are intended to cover the structures described herein as performing the recited function and not only structural equivalents, but also equivalent structures.

1. A spillage indication system for a concrete mixer vehicle, the system comprising:
one or more incline sensors for determining an inclination of the concrete mixer vehicle;
one or more rotation sensors for determining a rotation speed of a concrete mixing drum of the concrete mixer vehicle;
a spillage indicator for indicating a potential spillage of a concrete mix in the mixing drum to an operator of the concrete mixing vehicle;
one or more processors; and
a memory, the memory containing computer readable instructions that, when executed by the one or more processors, cause the system to perform operations comprising:
measuring the inclination of the concrete mixer vehicle using the one or more incline sensors;
measuring the rotation speed of the concrete mixing drum using the one or more rotation sensors;
determining, based on (i) a volume of the concrete mix in the mixing drum (ii) the inclination of the concrete mixer vehicle and (ii) the rotation speed of the concrete mixing drum, a predicted level line of the concrete mix in the mixing drum;
comparing the predicted level line to a position of a discharge hole of the concrete mixing drum; and
in response to determining that the predicted level line is above the discharge hole, activating the spillage indicator.

2. The system of claim 1, wherein determining the predicted level line of the concrete mix in the mixing drum comprises:
determining a change in level line of the concrete mix relative to a current level line; and
determining the predicted level line of the concrete mix from the current level line and the change in level line of the concrete mix relative to a current level line.

3. The system of claim 2, wherein determining the predicted level line of the concrete mix from the initial level line comprises modifying the determined change in level line based on a slump value-dependent response factor of the concrete mix prior to determining the predicted level line of the concrete mix.

4. The system of any of any preceding claim, wherein the operations further comprise determining a steady level line corresponding to a stationary concrete mixing vehicle on a flat surface based on geometry of the concrete mixing drum and the volume of the concrete mix in the mixing drum.

5. The system of any preceding claim, wherein the operations further comprise determining the volume of the concrete mix in the mixing drum from a payload weight of the concrete mix and a slump value of the concrete mix.

6. The system of any preceding claim, wherein the operations further comprise controlling rotation of the concrete mixing drum based on the predicted level line of the concrete mix.

7. The system of any preceding claim, wherein the operations are iterated for a plurality of time steps during a journey of the concrete mixing vehicle.

8. The system of any preceding claim, wherein the one or more incline sensors are configured to measure a current inclination of the of the concrete mixer vehicle and wherein the predicted level line of the concrete mix in the mixing drum comprises a current predicted level line of the concrete mix in the mixing drum.

9. The system of any preceding claim, wherein the one or more incline sensors are configured to predict a future inclination of the concrete mixer vehicle and wherein the predicted level line of the concrete mix in the mixing drum comprises a future predicted level line of the concrete mix in the mixing drum.

10. The system of any preceding claim, further comprising one or more accelerometers for determining a longitudinal acceleration of the concrete mixer vehicle, wherein the operation further comprise measuring a longitudinal acceleration of the concrete mixer vehicle using the one or more accelerometers and wherein determining the predicted level line of the concrete mix in the mixing drum is further based on (iv) the longitudinal acceleration of the concrete mixer vehicle.

11. A computer implemented method for determining a drum rotation schedule for a concrete mixing vehicle, the method comprising:
receiving a volume of concrete mix to be transported by the concrete mixing vehicle;
receiving a journey route for the concrete mixing vehicle;
for each of a plurality of locations in a sequence of locations on the received route:
determining, based on the received route, an estimated incline of the concrete mixing vehicle at a respective location on the route;
determining, based on (i) the volume of the concrete mix (ii) the estimated incline of the concrete mixing vehicle and (iii) geometry of the concrete mixing drum, an estimated level line of the concrete mix at the respective location;
determining, based on the estimated level line of the concrete mix at the respective location, a target drum rotation speed at the respective location.

12. The method of claim 11, wherein determining, based on the estimated level line of the concrete mix at the respective location, a target drum rotation speed at the respective location comprises:
determining that the estimated level line of the concrete mix at the respective location is above a position of a discharge hole of the concrete mixing drum;
in response to determining that the estimated level line of the concrete mix at the respective location is above a position of a discharge hole of the concrete mixing drum, determining a target drum rotation speed at the respective location that results in a respective estimated level line of the concrete mix that is below the discharge hole of the concrete mixing drum.

13. The method of claim 12, wherein determining a target drum rotation speed at the respective location that results in a respective estimated level line of the concrete mix that is below the discharge hole of the concrete mixing drum compromises iteratively, until the respective estimated level line of the concrete mix that is below the discharge hole of the concrete mixing drum:
increasing or decreasing the drum rotation speed;
determining, based on (i) the volume of the concrete mix (ii) the estimated incline of the concrete mixing vehicle (iii) geometry of the concrete mixing drum and (iv) the drum rotation speed, a respective estimated level line of the concrete mix at the respective location;
determining whether the respective estimated level line of the concrete mix at the respective location is above the position of the discharge hole of the concrete mixing drum

14. The method of any of claims 11 to 13, wherein the estimated level line of the concrete mix comprises the use of computational fluid dynamics.

15. The method of any of claims 11-14, wherein determining an estimated level line of the concrete mix at a respective location is further based on a target drum rotation speed at a previous location in the sequence of locations.

16. A computer program product comprising computer readable instructions that, when executed by system comprising one or more processors, cause the system to perform the operations of any of claims 1-9 or the method of any of claims 11-15.
